(19) United States
(12) Patent Application Publication
(10) Pub. No.: US 2026/0074578 A1
(43) Pub. Date: Mar. 12, 2026

(54) Covering Device for a Rotor With Two Steel Plates

(71) Applicant: Bayerische Motoren Werke Aktiengesellschaft, Muenchen (DE)

(72) Inventors: Maximilian Hallweger, Dachau (DE); Philipp Jacob, Kirchheim (DE)

(21) Appl. No.: 19/323,043

(22) Filed: Sep. 9, 2025

(30) Foreign Application Priority Data
Sep. 10, 2024 (DE) 102024125931.0

(51) Int. Cl. H02K 1/30; H02K 1/24; H02K 1/32

(52) U.S. Cl. CPC H02K 1/30; H02K 1/24; H02K 1/325

(57) ABSTRACT

A covering device for a rotor of an externally excited electric machine for covering winding heads, arranged on an end side of a rotor body of the rotor, of rotor windings of the rotor, includes: a first cover element with a first metal, profiled, deep-drawn cover plate for covering the winding heads which has a plurality of plate domes arranged in a circumferential distribution, wherein the plate domes form shell-like indentations for partially accommodating the winding heads on an underside of the first cover plate facing the winding heads, and bulges on an upper side of the first cover plate, and a second cover element with a second metal, rotationally symmetrical cover plate by which a disk-like cap arranged so that it axially overlaps the upper side of the first cover plate is formed. The cover plates are mechanically connected and a cavity is formed between the upper side of the first cover plate and the second cover plate.

### CROSS REFERENCE TO RELATED APPLICATION

This application claims priority under 35 U.S.C. § 119 from German Patent Application No. 10 2024 125 931.0, filed Sep. 10, 2024, the entire disclosure of which is herein expressly incorporated by reference.

### BACKGROUND AND SUMMARY

The invention relates to a covering device for a rotor of an externally excited electric machine for covering winding heads of rotor windings of the rotor arranged on an end side of a rotor body of the rotor. The invention moreover relates to a rotor.

The present document focuses on externally excited or current-excited electric machines for electrified motor vehicles, for example electric or hybrid vehicles. Such machines usually have a stationary stator and a rotor mounted rotatably with respect to the stator. The rotor has energizable rotor windings which are held by a rotor body, for example a rotor lamination stack. In the case of a rotor body with a salient-pole structure, winding conductors of the rotor windings are wound around the salient poles and are consequently arranged in portions in axial grooves of the rotor body. Winding portions of the rotor windings which are guided over the end sides of the rotor body form winding heads which protrude axially at the end sides. The rotor additionally usually has covering devices which axially cover the rotor body, covering and enclosing the winding heads. These covering devices can also be used to cool the winding heads. In order to optimize the cooling efficiency, the spacing between the winding heads and the covering device needs to be as small as possible in order to reduce thermal resistance.

To do this, the document DE 10 2022 111 413 A1 proposes to equip the rotor with at least one end-side part which is arranged on the end side of the rotor body, covers the rotor windings axially externally, and has a geometry which corresponds with an external contour of the rotor windings at its side facing the rotor base body. For stability reasons, the end-side part here takes the form of a die-cast part, in particular an aluminum die-cast part. Such die-cast parts are, however, complex and expensive to produce.

The object of the present invention is to provide a cost-effective and stable covering device providing a high degree of cooling efficiency for a rotor of an externally excited electric machine.

This object is achieved according to the invention by a covering device and a rotor having the features according to the respective independent claims. Advantageous embodiments of the invention are the subject of the dependent claims, the description and the drawings.

A covering device according to the invention for a rotor of an externally excited electric machine serves to cover winding heads, arranged on an end side of a rotor body of the rotor, of rotor windings of the rotor. The covering device comprises a first cover element with a first metal, profiled, deep-drawn cover plate for covering the winding heads which has a plurality of plate domes arranged in a circumferential distribution. The plate domes form shell-like indentations for at least partially accommodating the winding heads on an underside of the cover plate facing the winding heads, and bulges on an upper side of the first cover plate. Moreover, the covering device comprises a second cover element with a second metal, rotationally symmetrical cover plate by means of which a disk-like cap arranged so that it axially overlaps the upper side of the first cover plate is formed. The cover plates are mechanically connected and a cavity is formed between the upper side of the first cover plate and the second cover plate.

A rotor according to the invention for an externally excited electric machine comprises a rotor body, rotor windings which are held by the rotor body and form winding heads at opposite end sides of the rotor body, and at least one covering device according to the invention which is arranged so that it overlaps one of the end sides of the rotor body, covering the associated winding heads, and is mechanically connected to the rotor body. In particular, the rotor body comprises two covering devices according to the invention which are arranged axially on both sides of the rotor body. The rotor body in particular takes the form of a lamination stack of axially stacked sheet-metal laminations. The rotor body is in particular manufactured with a salient-pole structure and has an annular rotor yoke through which in particular a rotor shaft passes. The rotor shaft is connected non-rotatably to the rotor body. Distributed circumferentially on the rotor yoke are salient poles which in each case have a pole tooth which protrudes radially from the rotor yoke and in particular has parallel flanks, and a pole shoe which adjoins the pole tooth and projects tangentially or laterally at the pole tooth. A groove which extends between the two end sides axially through the rotor body is formed between two adjacent pole teeth. A pole gap, the tangential width of which is less than a tangential width of the respective groove and which forms an access opening for the respective groove, is formed between two adjacent pole shoes.

Axial winding portions of the rotor windings are arranged in the grooves. End-side winding portions of the rotor windings are arranged at the end sides, forming the winding heads. The rotor windings have in particular a wire-shaped winding conductor which is wound around the pole teeth in a plurality of layers and turns. Because the winding heads are subject to high mechanical stresses caused by rotation during operation of the electric machine, in particular in each case one star disk is arranged so that it bears against the respective end side and thus between the rotor body and the respective winding heads in order to support the winding heads. The star disk is additionally used for electrical insulation between the winding conductors and the rotor body.

The winding heads are additionally covered or enclosed by the covering devices. Each covering device here has a multi-part design and has two cover elements which are arranged so that they axially overlap each other. Each cover element has a cover plate which is preferably made from a steel plate. The cover elements can moreover have in each case a passage, formed as a through opening in the respective cover plate, for a rotor shaft connected non-rotatably to the rotor body. The through opening can take the form of a hole arranged centrally in the respective cover plate and formed, for example, by being stamped out of the steel plate.

The first cover plate is arranged adjacently to the winding heads. The cover plate here has a profile which is formed by cost-effective deep-drawing and follows a surface contour of the end side, equipped with the winding heads, of the rotor body. During the deep-drawing of the first cover plate, the plate domes are introduced which form the shell-like indentations or depressions on the underside. The indentations are cavities which are open in the underside at least in the direction of the end side, wherein each indentation accommodates in each case one winding head. Because of the indentations, the spacing between an upper surface of the winding head and the underside of the cover plate is substantially constant and can be particularly small in order to reduce the thermal resistance between the winding heads and the covering device. The plate domes form on the upper side, situated axially opposite the underside, of the first cover plate the bulges or protuberances by virtue of which an upper surface of the first cover plate is not rotationally symmetrical. The upper side of the first cover plate is thus not a surface of revolution.

In order to prevent this rotationally symmetrical upper surface causing turbulence at the rotating rotor during operation of the electric machine, by virtue of which efficiency of the electric machine is reduced, the upper side of the first cover plate is covered by the second cover element, forming the cavity. The second cover plate takes the form of the rotationally symmetrical plate-shaped cap. For example, the first cover plate can have a collar region, extending axially and projecting axially with respect to the bulges, on the circular rim of which the cap rests, enclosing the cavity. The cavity which results is thus delimited axially by the upper side of the first cover plate and thus the underside of the cap, and radially externally by the collar region of the first cover plate. The covering device thus has a double-walled closure plate.

The cover elements are mechanically connected such that the resulting covering device has a particularly high mechanical stability which is comparable with the mechanical stability of a die-cast part. For example, the cover elements can have connecting regions for mechanically connecting the cover elements which are formed as screw holes, arranged aligned with one another, in the cover plates. Screws via which the cover plates are mechanically connected are passed through these screw holes. The second cover plate can likewise be deep-drawn. Thus, for example, a channel running circumferentially or an annular groove can be formed in an upper side of the cap, in which the screw holes can be situated such that the screw heads are arranged, countersunk, when the cover elements are screwed on and thus do not project from the cap. The covering device can additionally be screwed tight to the associated star disk via the screws for mechanical connection to the rotor body.

The covering device preferably has an annular jacket element which is formed so that it extends from a rim of the cap in the direction of the end sides and which radially surrounds the first cover element. In the arranged state of the jacket element, the first cover plate thus forms an interior or inner cover plate and the second cover plate forms an exterior or outer cover plate. The jacket element can, for example, take the form of a cylindrical steel bandage. For example, the jacket element can close the indentations which are also open radially externally. The jacket element can moreover surround the respective star disk and stabilize the star disks by axially protruding star disk roofs of the star disks arranged radially externally being supported against an inner surface of the jacket element.

It has proven to be advantageous if the cavity takes the form of a cooling duct for guiding a coolant designed to cool the winding head. The coolant, which can for example take the form of a cooling liquid in the form of oil, can be guided closely past the winding heads through the first cover plate arranged with a small spacing from the winding heads, and thus absorb and transport away the waste heat of the winding heads. The covering device can have, for example, an inlet region which is arranged aligned with coolant outlet openings in the coolant-guiding rotor shaft of the rotor, and an outlet region for the radial outlet of the coolant conducted in the cavity. The outlet openings can take the form of, for example, slots in the cap. For this purpose, the rotor shaft can take the form of a hollow shaft for guiding the coolant and have in a wall the coolant discharge openings for the outlet of the coolant into the cavity of the at least one covering device. The coolant can here be transported solely due to centrifugal force by rotation of the rotor from the radially interior inlet region to the radially exterior outlet region. By virtue of the radial outlet of the coolant, the latter can as a result of the rotation be thrown against winding heads of the stator surrounding the rotor and thus advantageously additionally be used to cool the stator winding heads.

The first cover element can moreover have collection regions for collecting the coolant which take the form of seams in the upper side of the first cover plate. The seams can collect the coolant at regions of the winding heads which are at risk of overheating before it is output due to centrifugal force via the outlet openings. The seams can be arranged in a circumferential distribution on the upper side. For example, in each case a bead can be arranged between two adjacent bulges. Particularly reliable cooling of the rotor winding heads can thus be ensured.

The embodiments presented with reference to the covering device according to the invention and their advantages apply correspondingly to the rotor according to the invention.

Further features of the invention can be found in the claims, the drawings, and the description of the drawings. The features and combinations of features mentioned above in the description and the features and combinations of features mentioned below in the description of the drawings and/or shown solely in the drawings can be used not only in the combination specified in each case but also in other combinations or on their own.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic perspective illustration of a rotor with a covering device; and

FIG. 2 is a schematic perspective illustration of the rotor with a first cover element of the covering device

The same elements and those with the same function are provided in the Figures with the same reference signs.

### DETAILED DESCRIPTION OF THE DRAWINGS

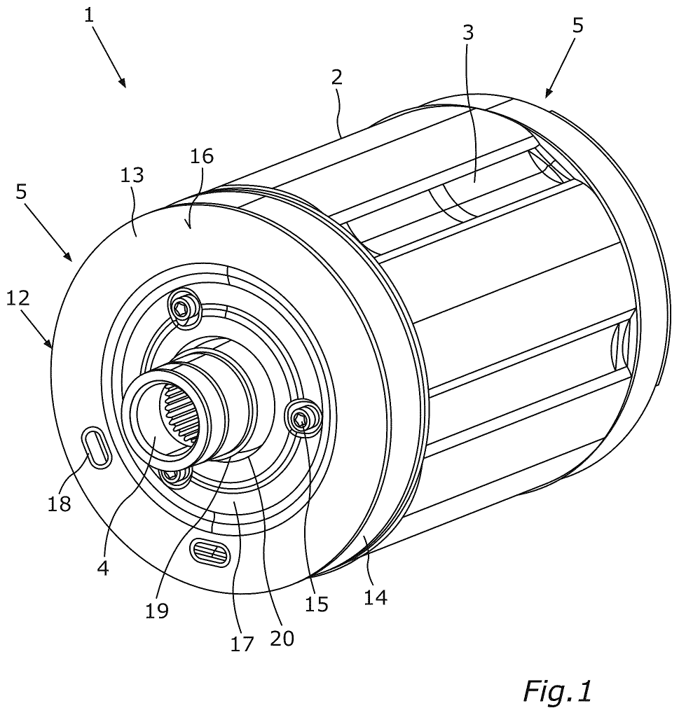

FIG. 1 shows a rotor 1 for an externally excited electric machine which can be used, for example, as a drive machine for an electrified motor vehicle. The rotor 1 here takes the form of an internal rotor and can be mounted rotatably inside a hollow-cylindrical stator of the electric machine. The rotor 1 has a rotor body 2. The rotor body 2 has grooves for accommodating rotor windings (not visible here) of the rotor 1, wherein the grooves are here closed by groove-closure elements 3 or sliding covers. Passing through the rotor body 2 is a rotor shaft 4 which here takes the form of a hollow shaft and is designed to guide a coolant axially through the rotor body 2. The rotor 1 moreover has two covering devices 5 which are arranged so that they overlap the end sides of the rotor body 2 and are designed to enclose winding heads of the rotor windings.

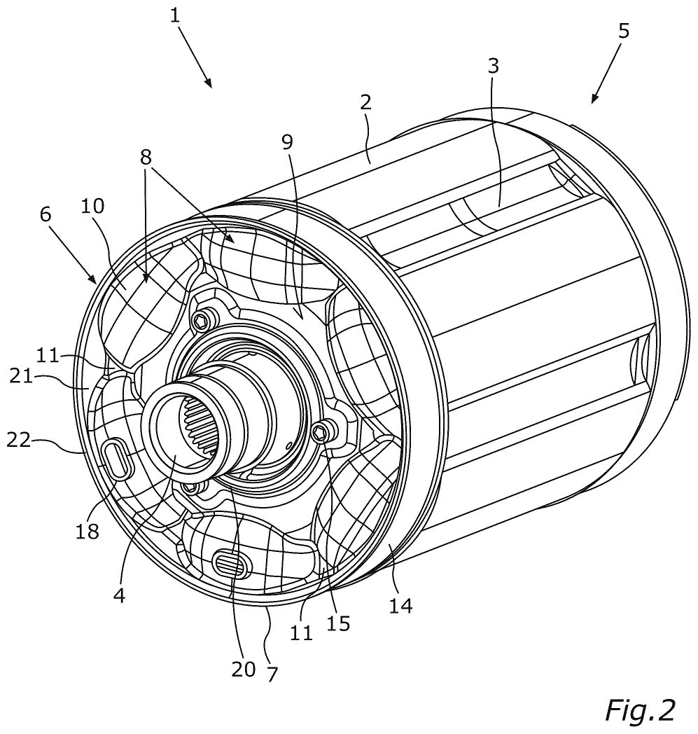

Each covering device 5 has, as shown in FIG. 2, a first cover element 6 with a three-dimensionally deep-drawn first cover plate 7. The cover plate 7 consists of a steel plate and has plate domes 8 formed by deep-drawing. These plate domes 8 form, on an underside (not visible here) of the first cover plate 7, indentations for accommodating the winding heads. The plate domes 8 form bulges 10 on an upper side 9 of the first cover plate 7. Seams 11 are moreover here formed between two bulges 10 on the upper side 9. A collar region 21 with an annular rim 22 of the first cover plate 7 is here formed so that it protrudes axially from the bulges 10.

Arranged overlapping the upper side 9 of the first cover plate 7 is a second cover element 12 which has a second cover plate 13 which in particular likewise consists of a steel plate and forms a rotationally symmetrical plate-like cap. The cap 13 can rest, for example, on the rim 22. A jacket element 14, which here takes the form of a steel band, surrounds the winding heads radially and extends axially from the end side of the rotor body 2 as far as the second cover plate 13. By virtue of the formation of the cover plates 7, 13 as steel plates, the latter readily ensure the required strength with low material requirements and are much less expensive to produce. In addition, the cooling performance to be expected is equivalent to that of a conventional aluminum die-cast cap.

The cover elements 6, 12 are mechanically connected via screws 15 by means of which the covering device 5 can additionally be fastened to the rotor body 2. For this purpose, the cover elements 6, 12 have fastening regions which are formed by screw holes, arranged aligned with one another, in the associated cover plates 7, 13. An upper side 16 of the cap 13 has a channel 17 or groove formed, for example, by deep-drawing and in which the screw holes are arranged for countersunk arrangement of the screws 15. Moreover, the two cover plates 7, 13 here have filling openings 18, arranged aligned with one another, for a potting compound for potting the rotor 1. The covering device 5 moreover has a passage 19 for the rotor shaft 4 which is formed by through openings 20, arranged aligned with one another, of the cover plates 7, 13.

The mechanically connected cover elements 6, 12 form a covering device 5 with an essentially rotationally symmetrical, turbulence-reducing upper surface. In addition, the cover elements 6, 12 enclose a cavity which forms a cooling duct for a coolant for cooling the winding heads. The coolant supplied by the rotor shaft 4 in the form of a hollow shaft can thus be caught between the cover plates 7, 13 in order to fully exploit the cooling potential of the covering device 5. The coolant is here not ripped away from the end side during the rotation of the rotor 1 by the ambient air in the electric machine space and can lie uniformly on the upper side 9 of the first cover plate 7 and extract the heat better from the first cover plate 7. Furthermore, the coolant can be collected by the seams 11 in the first cover plate 7 in order to further maximize the cooling power before it is thrown through discharge openings which are arranged, for example, in the second cover plate 13.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A covering device for a rotor of an externally excited electric machine for covering winding heads, arranged on an end side of a rotor body of rotor windings of the rotor, comprising:
a first cover element with a first metal, profiled, deep-drawn cover plate for covering the winding heads, the first cover plate having a plurality of plate domes arranged in a circumferential distribution, wherein the plate domes form shell-shaped indentations for partially accommodating the winding heads on an underside of the first cover plate facing the winding heads, and bulges on an upper side of the first cover plate;
a second cover element with a second metal, rotationally symmetrical, cover plate by which a disk-shaped cap arranged so as to axially overlap the upper side of the first cover plate is formed,
wherein the first and second cover plates are mechanically connected, and a cavity is formed between the upper side of the first cover plate and the second cover plate.

2. The covering device according to claim 1, wherein the first and second cover plates are made from a steel plate.

3. The covering device according to claim 1, further comprising:
an annular jacket element which is formed so as to extend from a rim of the second cover plate in a direction of the respective end side and which radially surrounds the first cover element.

4. The covering device according to claim 1, wherein
the first cover plate has a collar region, extending axially and projecting axially with respect to the bulges, on which the second cover plate rests, enclosing the cavity.

5. The covering device according to claim 1, wherein the cavity forms a cooling duct for guiding a coolant designed to cool the winding head.

6. The covering device according to claim 5, further comprising:
an inlet region which is arranged aligned with coolant discharge openings in a coolant-guiding rotor shaft of the rotor, and
an outlet region for a radial outlet of the coolant conducted in the cavity.

7. The covering device according to claim 5, wherein
the first cover element has collection regions for collecting the coolant, which collection regions take the form of seams in the upper side of the first cover plate.

8. The covering device according to claim 1, wherein
The first and second cover elements have connecting regions for mechanically connecting the cover elements, which connection regions are formed as screw holes, arranged aligned with one another, in the first and second cover plates.

9. A rotor for an externally excited electric machine, comprising:
a rotor body;
rotor windings which are held by the rotor body and form winding heads at opposite end sides of the rotor body; and
at least one covering device according to claim 1,
wherein the at least one covering device is arranged so as to overlap one of the end sides of the rotor body, covering the associated winding heads, and being mechanically connected to the rotor body.

10. The rotor according to claim 9, wherein
the rotor has a rotor shaft which passes axially through the rotor body and the at least one covering device and is connected non-rotatably to the rotor body, and
the rotor shaft takes the form of a hollow shaft for guiding a coolant and has discharge openings for outlet of the coolant into the cavity of the at least one covering device.
